(19) United States
(12) Patent Application Publication
(10) Pub. No.: US 2026/0160702 A1
(43) Pub. Date: Jun. 11, 2026

(54) INSPECTION SYSTEM AND INSPECTION MODULE

(71) Applicant: WNC Corporation, Hsinchu (TW)

(72) Inventors: Hsiang Pin CHANG, Hsinchu (TW); Guan Jhang DING, Hsinchu (TW)

(21) Appl. No.: 19/413,159

(22) Filed: Dec. 9, 2025

(30) Foreign Application Priority Data
Dec. 11, 2024 (TW) 113148122

(51) Int. Cl. G01N 21/88

(52) U.S. Cl. CPC G01N 21/8851; G01N 2021/887; G01N 2201/025

(57) ABSTRACT

An inspection module for inspecting a workpiece includes a receiving module and a side vision module. The receiving module includes a receiving fixture and a receiving rotation shaft configured to hold and rotate the workpiece. The side vision module includes a side-view camera. The receiving module is configured to: (1) position the workpiece held by the receiving fixture in front of the side-view camera so that the side-view camera captures a first side image of the workpiece; and (2) rotate the workpiece held by the receiving fixture by a predetermined angle through the receiving rotation shaft so that the side-view camera captures a second side image of the workpiece. The first side image and the second side image correspond to different side-view positions of the workpiece.

### RELATED APPLICATIONS

This application claims priority to Taiwan Application Serial Number 113148122, filed Dec. 11, 2024, which is herein incorporated by reference.

### BACKGROUND

### Technical Field

The present disclosure relates to inspection equipment. More particularly, the present disclosure relates to automated inspection equipment for inspecting workpieces.

### Description of Related Art

Workpieces (such as electronic components) are widely used in various products. To ensure the workpieces function properly, inspections are typically performed, such as visual inspection. Visual inspection can use cameras or other devices to take pictures of the workpieces, and can be paired with lenses to magnify the images to visually check for defects. The inspection of workpieces can be conducted from various directions, such as the six faces of top, bottom, left, right, front and back. Conventional inspection equipment requires a long time to inspect the six faces of a workpiece, and the equipment often occupies a large area. As a result, the equipment is expensive and does not meet economic efficiency while failing to achieve the need for mass testing. Moreover, conducting different inspection items requires more time, and different inspection modules will also enlarge the equipment size.

In view of the above issues, there is a need for a fast, compact inspection solution capable of conducting different inspection items.

### SUMMARY

According to one aspect of the present disclosure, an inspection module for inspecting a workpiece includes a receiving module and a side vision module. The receiving module includes a receiving fixture and a receiving rotation shaft. The receiving fixture is configured to hold the workpiece, and the receiving rotation shaft is coupled to the receiving fixture and configured to rotate the receiving fixture. The side vision module includes a pair of side-view cameras. The receiving module is configured to: place the workpiece held by the receiving fixture between the side-view cameras, allowing the side-view cameras to capture a first pair of side images of the workpiece; and rotate the workpiece held by the receiving fixture by an angle through the receiving rotation shaft, allowing the side-view cameras to capture a second pair of side images of the workpiece. The first pair of side images and the second pair of side images correspond to different side-view positions of the workpiece.

According to another aspect of the present disclosure, an inspection system for inspecting a workpiece includes a picking module, a top vision platform, a top vision module, a receiving module, a bottom vision module and a side vision module. The picking module includes a picking fixture, and the picking fixture is configured to hold the workpiece. The top vision platform is configured to support the workpiece from the picking fixture, and the picking fixture is configured to place the workpiece on the top vision platform while the picking fixture is located in a safety zone. The top vision module includes a top-view camera, and the top-view camera is configured to capture a top image of the workpiece carried on the top vision platform from above the workpiece. The receiving module includes a receiving fixture and a receiving rotation shaft. The receiving fixture is configured to acquire and hold the workpiece from the top vision platform, and the receiving rotation shaft is coupled to the receiving fixture and configured to rotate the receiving fixture. The bottom vision module includes a bottom-view camera, and the bottom-view camera is configured to capture a bottom image of the workpiece held by the receiving fixture from below the workpiece. The side vision module includes a side-view camera, and the side-view camera is configured to capture a side image of the workpiece held by the receiving fixture from a side of the workpiece. During a period in which the picking fixture places the workpiece on the top vision platform, the picking fixture enters the safety zone and the top vision module is retracted from the safety zone; and during a period in which the top vision module captures the top image of the workpiece, the top vision module enters the safety zone and the picking fixture is retracted from the safety zone.

According to yet another aspect of the present disclosure, an inspection module for inspecting a workpiece includes a picking module, a top vision platform, a top vision module, a receiving module, a bottom vision module and a side vision module. The picking module includes a picking fixture, and the picking fixture is configured to hold the workpiece. The top vision platform is configured to support the workpiece from the picking fixture. The top vision module includes a top-view camera, and the top-view camera is configured to capture a top image of the workpiece carried on the top vision platform from above the workpiece. The receiving module includes a receiving fixture and a receiving rotation shaft. The receiving fixture is configured to acquire and hold the workpiece from the top vision platform, and the receiving rotation shaft is coupled to the receiving fixture and configured to rotate the receiving fixture. The bottom vision module includes a bottom-view camera, and the bottom-view camera is configured to capture a bottom image of the workpiece held by the receiving fixture from below the workpiece. The side vision module includes a pair of side-view cameras. The receiving module is configured to: place the workpiece held by the receiving fixture between the side-view cameras, allowing the side-view cameras to capture a first pair of side images of the workpiece; and rotate the workpiece held by the receiving fixture by an angle through the receiving rotation shaft, allowing the side-view cameras to capture a second pair of side images of the workpiece. The bottom image is captured simultaneously with the first pair of side images, and/or the bottom image is captured simultaneously with the second pair of side images.

### BRIEF DESCRIPTION OF THE DRAWINGS

The disclosure can be more fully understood by reading the following detailed description of the embodiments, with reference made to the accompanying drawings as follows:

FIG. 1A illustrates a top view of an inspection system according to an embodiment of the present disclosure.

FIG. 1B illustrates a schematic diagram of the inspection system according to the embodiment of the present disclosure.

FIG. 2A illustrates a side view of a loading and unloading machine according to an embodiment of the present disclosure.

FIG. 2B illustrates a schematic diagram of the loading and unloading machine according to the embodiment of the present disclosure.

FIG. 3 illustrates a schematic diagram of a picking module according to an embodiment of the present disclosure.

FIG. 4 illustrates a schematic diagram of a fixture according to an embodiment of the present disclosure.

FIG. 5 illustrates a schematic diagram of a top vision platform according to an embodiment of the present disclosure.

FIG. 6A illustrates a side view of a top vision module according to an embodiment of the present disclosure.

FIG. 6B illustrates a schematic diagram of the top vision module according to the embodiment of the present disclosure.

FIG. 7 illustrates a schematic diagram of a receiving module according to an embodiment of the present disclosure.

FIG. 8A illustrates a side view of a bottom vision module according to an embodiment of the present disclosure.

FIG. 8B illustrates a schematic diagram of the bottom vision module according to the embodiment of the present disclosure.

FIG. 9A illustrates a side view of a side vision module according to an embodiment of the present disclosure.

FIG. 9B illustrates a schematic diagram of the side vision module according to the embodiment of the present disclosure.

FIG. 10A illustrates a schematic diagram of a configuration of an ionizer bar according to an embodiment of the present disclosure.

FIG. 10B illustrates an enlarged schematic diagram of the configuration of an ionizer bar according to an embodiment of the present disclosure.

FIG. 10C illustrates a schematic diagram of the inspection system covered with a housing according to an embodiment of the present disclosure.

### DETAILED DESCRIPTION

The present disclosure provides an inspection system that utilizes the top vision module, bottom vision module and side vision module to simultaneously conduct different inspection items on different workpieces, allowing all inspection items of the six-face (e.g., top, bottom, left, right, front, back) inspection process to be completed within five seconds. Additionally, different inspection items can be conducted on the same face. The inspection system of the present disclosure can also reduce equipment footprint through the mutual avoidance function between the inspection module and the pick-and-place transfer mechanism, achieving equipment miniaturization and mass inspection functionality. The inspection system of the present disclosure can be, for example, an Automated Visual Inspection (AVI) equipment, but the present disclosure is not limited thereto.

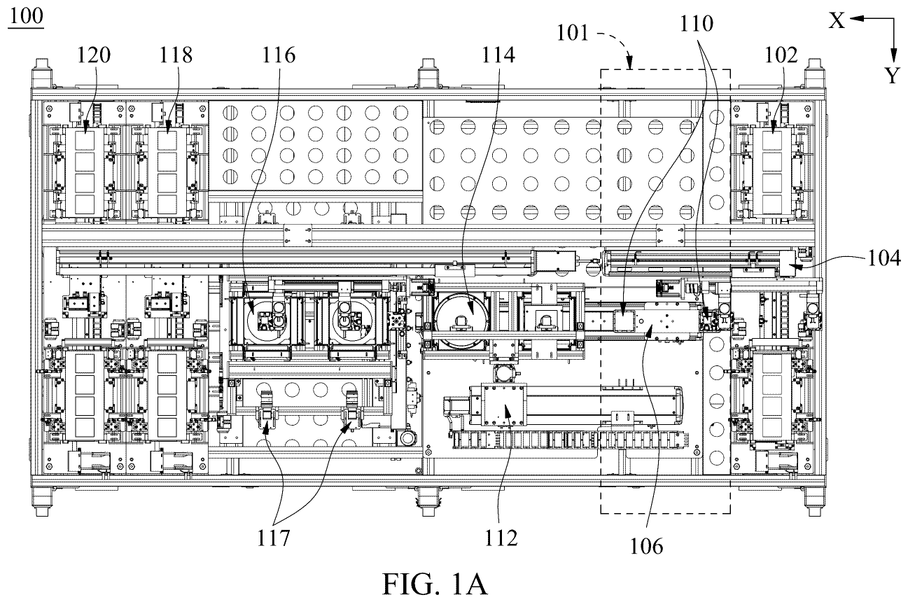

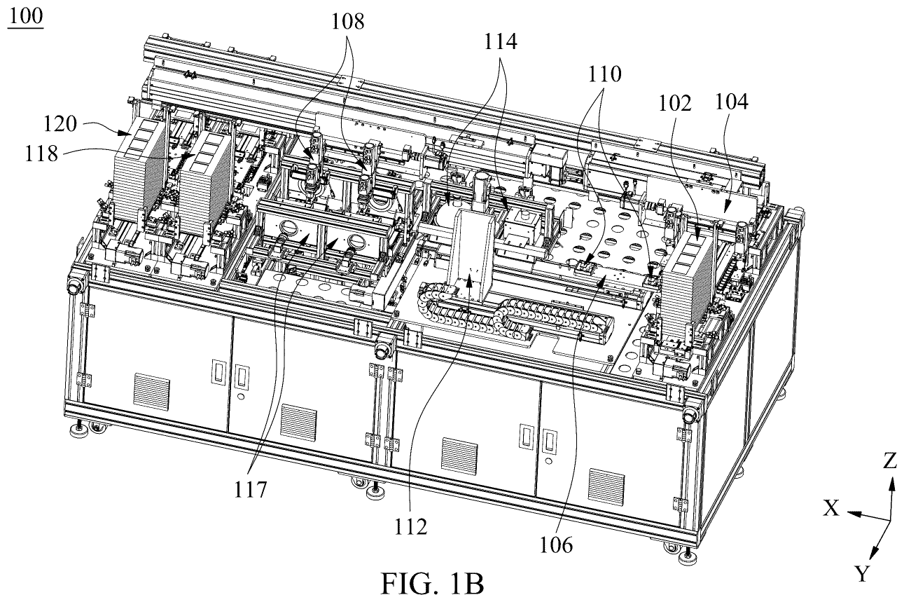

FIGS. 1A and 1B illustrate an inspection system 100 according to an embodiment of the present disclosure from different angles. Referring to FIGS. 1A and 1B, the operational stages of the inspection system 100 can be generally divided into: (a) loading, (b) inspection, and (c) sorting and unloading. Below, the operation of each stage will be briefly explained from right to left in FIG. 1A.

During the loading stage, an operator places a tray containing workpieces to be inspected (not shown) on a loading machine 102. Each tray in this embodiment has four material slots 110, and each material slot 110 is approximately square-shaped and can load a workpiece of about 65*65 mm, but the present disclosure is not limited thereto; those skilled in the art can choose appropriate trays based on the need to inspect workpieces of different sizes or types, and the trays can have other numbers of material slots 110 or material slot shapes. The loading machine 102 has a conveyor belt capable of transporting the workpieces in a Y-axis direction to a position convenient for the picking module 104 to pick up the material, referred to as the picking position. In the embodiment of FIGS. 1A and 1B, the picking module 104 has two fixtures (not shown) arranged in an X-axis direction. First, the loading machine 102 translates a workpiece in the Y-axis direction to the picking position, and the first fixture moves above the picking position to obtain the workpiece from the loading machine 102. After acquiring the workpiece, the first fixture translates in the X-axis direction to leave the picking position. Subsequently, the loading machine 102 translates again in the Y-axis direction to move the next workpiece to the picking position, and the second fixture moves above the picking position to obtain another workpiece from the loading machine 102. After the picking module 104 acquires the workpieces, the subsequent inspection stages can then be performed.

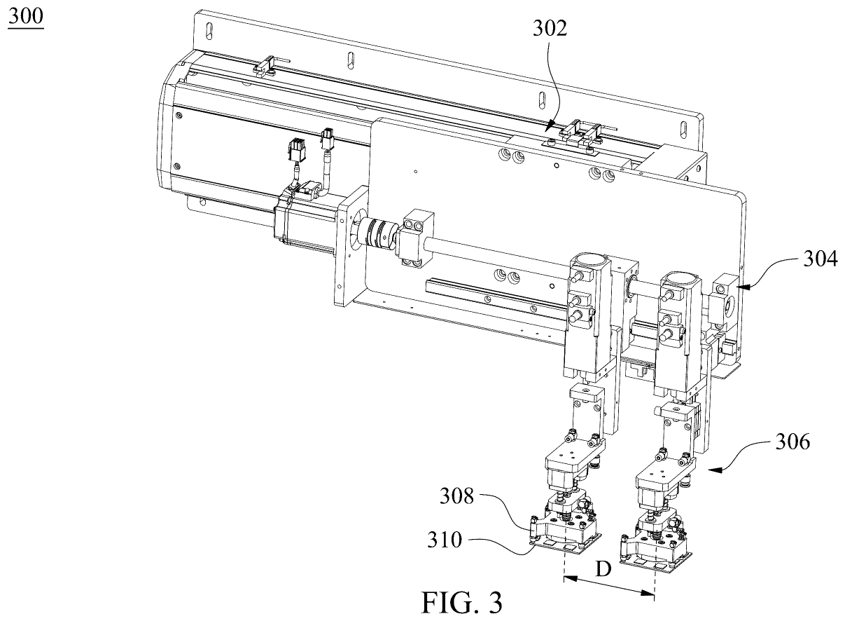

The picking module 104 has a picking X-axis (marked in FIG. 3), and the top vision module 114 has a top vision X-axis 112, enabling the picking module 104 and the top vision module 114 to move individually in the X-axis direction. The picking module 104 moves the obtained two workpieces in the X-axis direction to above the top vision platform 106 to place the two workpieces individually in two material slots 110 of the top vision platform 106. Then the top vision platform 106 and the top vision module 114 move toward each other. When the top vision module 114 overlaps with one or more workpieces carried on the top vision platform 106 in a crosswise manner, the top vision module 114 captures images of the workpieces from above to obtain top images of the workpieces for visual inspection.

The top vision module 114 and the picking module 104 can be configured with a “yielding” arrangement to reduce the footprint of the inspection system 100. When the picking module 104 is placing the workpieces on the top vision platform 106, the top vision module 114 is retracted from and moves away from the safety zone 101 in the X-axis direction to make space for the picking module 104, allowing the picking module 104 to enter the safety zone 101 and move above the top vision platform 106 to place the workpieces. After the picking module 104 has placed the workpieces on the top vision platform 106, the picking module 104 is retracted from and moves away from the safety zone 101 in the X-axis direction (returning to above the loading machine 102) to make space for the top vision module 114, allowing the top vision module 114 to enter the safety zone 101 and move above the top vision platform 106 for capturing images. This yielding design of the inspection system 100 allows the placement and inspection operations to be conducted in a small space, thereby reducing the footprint of the entire inspection system 100.

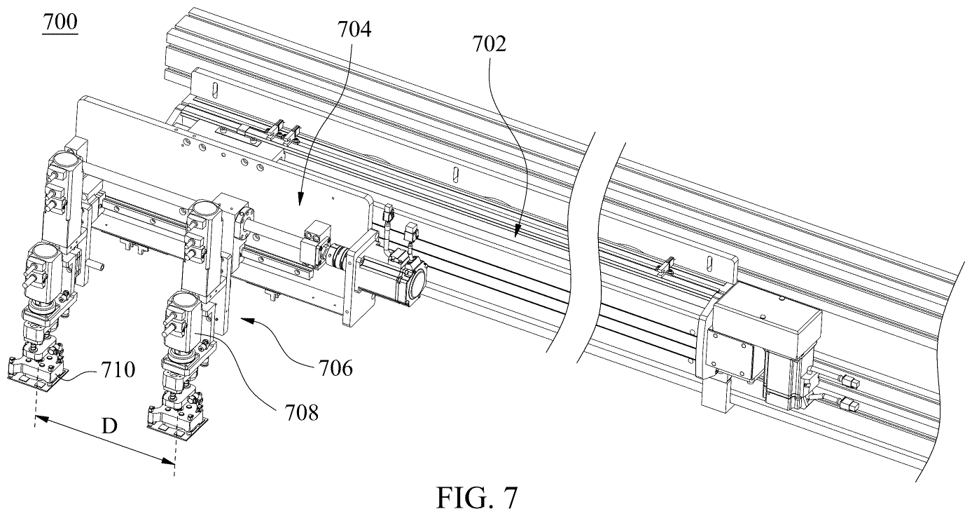

After the top vision module 114 completes the inspection, the top vision platform 106 moves forward to a position convenient for the receiving module 108 to collect the material, referred to as the receiving position. The terms “picking” and “receiving” here refer to the action of the corresponding mechanism (e.g., picking module 104, receiving module 108) obtaining the workpieces. Although the actions are similar, they are conducted by different mechanisms or used for different inspections, hence distinguished by the names “picking” and “receiving”. The receiving module 108 has fixtures (not shown) configured to acquire and hold workpieces carried on the top vision platform 106 at the receiving position. The receiving module 108 is coupled to the receiving X-axis (marked in FIG. 7), enabling the receiving module 108 to move in the X-axis direction. The receiving module 108 moves the obtained two workpieces to the bottom vision module 116 and the side vision module 117 for visual inspection from below and beside the workpieces. As shown in FIG. 1A, the bottom vision module 116 and the side vision module 117 are approximately set at the same position, where the bottom vision module 116 conducts inspection from below the workpieces (e.g., obtaining bottom images), and the side vision module 117 conducts inspection from the side of the workpieces (e.g., obtaining side images). Since the bottom images and side images of the workpieces can be obtained at the same position and simultaneously, it is unnecessary to move to different positions for different directional inspections, so the design of the bottom vision module 116 and the side vision module 117 can speed up the inspection speed of the workpieces and also reduce the overall footprint of the inspection system 100.

The side vision module 117 is equipped with cameras arranged in pairs in the Y-axis direction. When the workpiece is placed between the paired cameras of the side vision module 117 through the receiving module 108, the side vision module 117 can simultaneously obtain side images from two sides of the workpiece. In order to fully inspect all sides of the workpiece (e.g., front, back, left, and right sides, but not limited to quadrilateral), the receiving module 108 further includes a receiving rotation shaft (marked in FIG. 7) configured to rotate the workpiece so that the side vision module 117 can capture images of different sides of the same workpiece. For example, the side vision module 117 can first obtain a first pair of side images of the first side and the opposite second side of the workpiece, then use the receiving rotation shaft to rotate the workpiece by 90 degrees to allow the side vision module 117 to obtain a second pair of side images of the third side and the opposite fourth side of the workpiece. The rotation angle of the receiving rotation shaft is not limited to 90 degrees. It can rotate by other angles. Through the design of the receiving rotation shaft of the receiving module 108, inspections can be conducted on various different sides of the workpieces at the same position, further reducing the footprint of the inspection system 100.

After the comprehensive inspection by the top vision module 114, bottom vision module 116 and side vision module 117, the system determines whether the individual workpiece passes or fails the inspection and then places the workpiece into a pass unloading machine 120 or a fail unloading machine 118, thereby performing sorting. The operator can then take away the sorted workpieces. The inspection system 100 in the embodiment of FIGS. 1A and 1B, through the yielding design between the picking module 104 and the top vision module 114, and conducting bottom and side visual inspections at the same position, can control the length, width, and height dimensions of the entire inspection system 100 (including the housing covering the inspection system 100) to be approximately 2800, 1400, 2000 mm, respectively, or smaller.

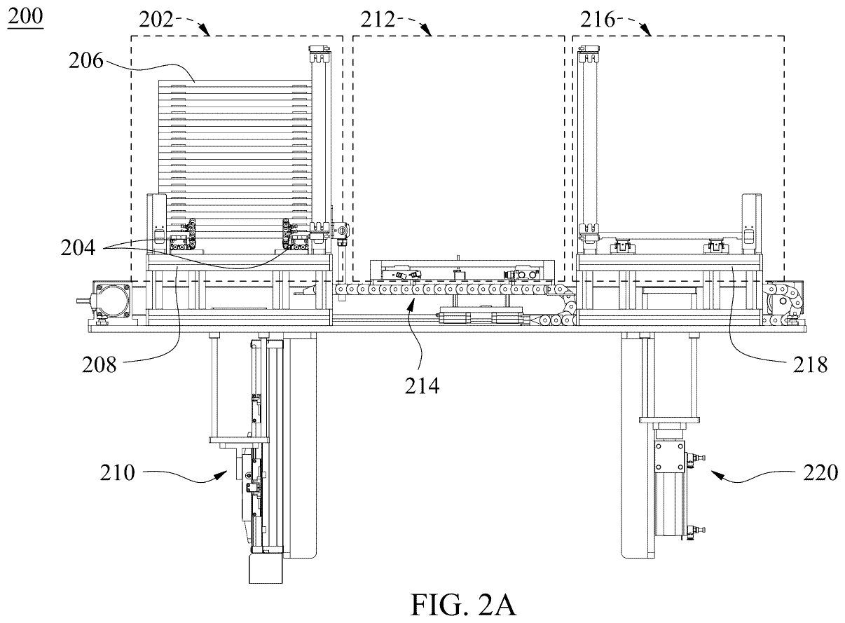

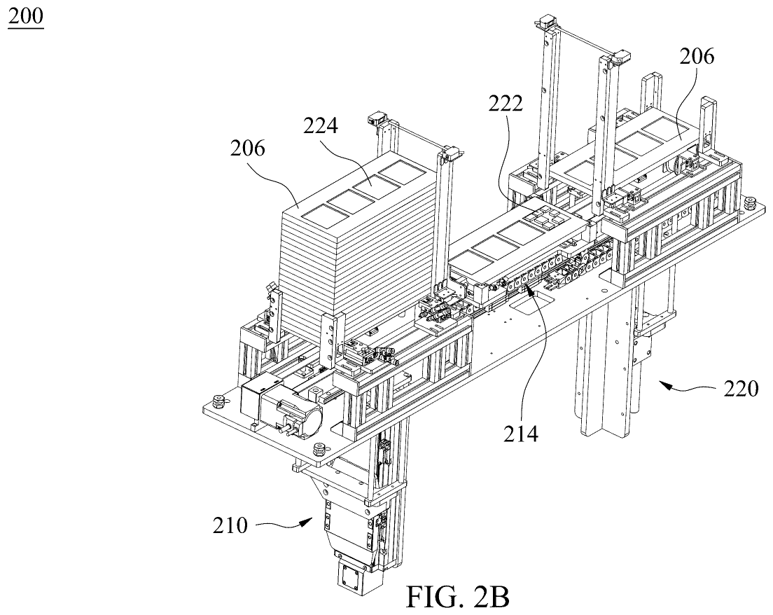

The structural design of the fail unloading machine 118 and the pass unloading machine 120 is similar to the loading machine 102, which will be further described with FIGS. 2A and 2B.

FIGS. 2A and 2B illustrate a loading and unloading machine 200 according to an embodiment of the present disclosure from different angles. The loading and unloading machine 200 can correspond to the loading machine 102, fail unloading machine 118, or pass unloading machine 120 in FIGS. 1A and 1B, but although the structure is similar, the operation mode can be adjusted based on demand.

Referring to FIGS. 2A and 2B, and taking the loading operation as an example, the loading and unloading machine 200 can be generally divided into three areas: the tray input stacking position 202, the picking position 212 and the tray pickup stacking position 216. The operator stacks the trays 206 carrying workpieces 222 to be inspected in the material slots 224 at the tray input stacking position 202 to allow the loading and unloading machine 200 to conduct tray separation and supply. First, a tray separation Z-axis 210 rises to push the tray 206 out of a tray separation cylinder 204; the tray separation cylinder 204 opens, the tray separation Z-axis 210 descends by the distance of one tray 206; the tray separation cylinder 204 clamps the tray 206; the tray separation Z-axis 210 moves to a tray input standby position 208. Then the transfer mechanism 214 moves to the tray input standby position 208; the tray separation Z-axis 210 descends to place the tray 206 on the transfer mechanism 214; the transfer mechanism 214 moves the tray 206 to the picking position 212 for the picking module (not shown in FIGS. 2A and 2B) to pick up the workpieces; after the pick-up is completed, the transfer mechanism 214 moves the empty tray 206 to a tray pickup standby position 218. Next, a stacking Z-axis 220 rises to push the tray 206 to the tray pickup stacking position 216 for stacking the empty tray 206; the transfer mechanism 214 returns to the tray input standby position 208, and the stacking Z-axis 220 descends; finally, the operator can take away the stacked empty trays 206.

After the inspection is completed, the unloading operation can be conducted using steps similar to the loading operation. For example, the operator places the empty trays 206 at the tray input stacking position 202; the transfer mechanism 214 moves to the tray input standby position 208 to receive the empty trays 206. Then the transfer mechanism 214 moves the empty trays 206 to the picking position 212 to receive the inspected workpieces 222. The receiving module (not shown in FIGS. 2A and 2B) places the inspected workpieces 222 on the trays 206 on the transfer mechanism 214; the transfer mechanism 214 moves to the tray pickup standby position 218, and the stacking Z-axis 220 rises to push the trays 206 out for stacking. The operator can then take away the stack of trays 206 containing the inspected workpieces 222.

Based on the foregoing, the loading and unloading machine 200 has a pre-tray-separation function, allowing the tray separation process to be completed in advance, so when, the transfer mechanism 214 moves to a position below it, the material can be directly released, thereby saving tray changing time. The stacking Z-axis 220 is specially designed to avoid interference with the transfer mechanism 214, such that when the tray 206 just disengages from the transfer mechanism 214, the transfer mechanism 214 can directly move away from the tray pickup stacking position 216 and return to the tray input standby position 208 without having to wait for the stacking Z-axis 220 to complete its operation before leaving. The above designs collectively reduce equipment's operation time.

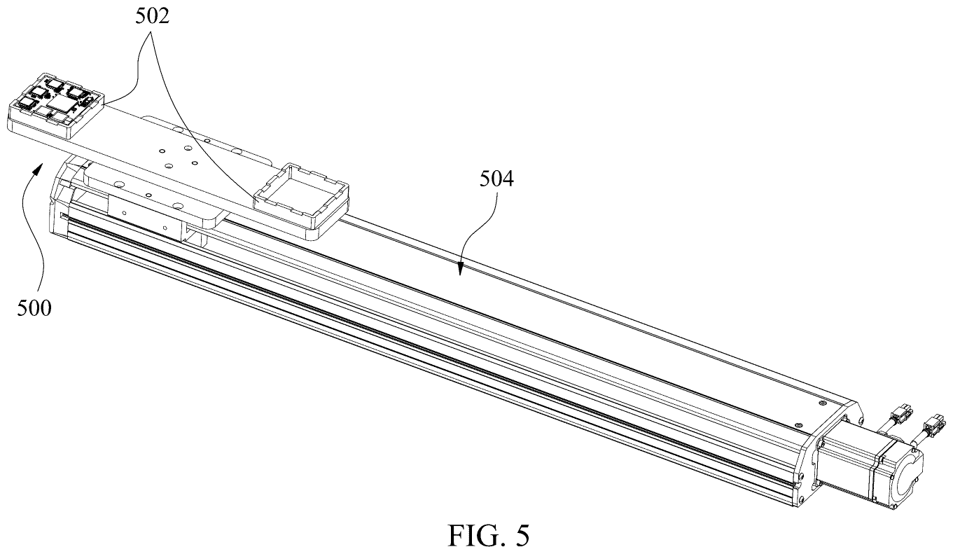

FIG. 3 illustrates a picking module 300 according to an embodiment of the present disclosure. The picking module 300 includes a picking fixture 308, with the picking fixture 308 configured to hold the workpieces 310. In the embodiment of FIG. 3, the picking module 300 further includes a picking pitch-adjusting module 304, with two picking fixtures 308 coupled to it. The picking pitch-adjusting module 304 is further coupled to a picking X-axis 302. The configuration of the picking pitch-adjusting module 304 and the picking X-axis 302 provides various ways to move the workpiece 310 in the X-axis direction. For example, the picking pitch-adjusting module 304 can change the center distance D between the two picking fixtures 308, or fix the center distance D between the two picking fixtures 308 and move them in parallel through the picking X-axis 302, or move the two picking fixtures 308 on the X-axis 302 while simultaneously changing the center distance D between the two picking fixtures 308. A picking Z-axis 306 is coupled between the picking fixture 308 and the picking pitch-adjusting module 304, enabling the picking fixture 308 to move in the Z-axis direction for obtaining or placing the workpieces 310 more conveniently. In some embodiments, due to the miniaturized design of the picking Z-axis 306, the minimum center distance D between the two picking fixtures 308 on the picking pitch-adjusting module 304 can be shortened to 4.5 cm. The picking pitch-adjusting module 304 can adjust the distance between the two held workpieces 310 to match the spacing of the material slots of the top vision platform in subsequent process. For example, when the distance between the two material slots of the top vision platform is greater than the aforementioned center distance D (4.5 cm), the picking module 300 can place two workpieces 310 in the two material slots at once. The top vision platform will be described below with FIG. 5.

The embodiment in FIG. 3 is merely an example, and the present disclosure may include other variations. For example, in some embodiments, more or fewer picking fixtures 308 can be coupled to the picking pitch-adjusting module 304. In some other embodiments, the picking Z-axis 306 can be directly coupled to the picking X-axis 302 without going through the picking pitch-adjusting module 304. In other embodiments, a picking rotation shaft may be coupled between the picking fixture 308 and the picking Z-axis 306, allowing the picking fixture 308 to rotate on the picking Z-axis 306.

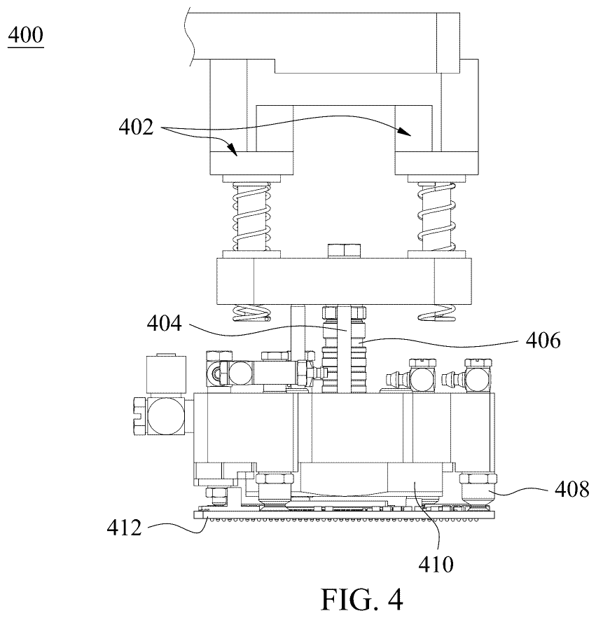

FIG. 4 is an enlarged view of a fixture 400, which can be applied to various modules of the present disclosure, including but not limited to the picking module and the receiving module. The fixture 400 includes a contact suction cup 408 and a non-contact suction cup 410, which use airflow principles (e.g., Bernoulli principle) to pick up a workpiece 412. The contact suction cup 408 is distributed around the periphery of the non-contact suction cup 410, with the contact suction cup 408 configured to contactly adsorb the peripheral area of the workpiece 412, while the non-contact suction cup 410 non-contactly adsorbs the central area of the workpiece 412. The contact suction cup 408 is configured to press against the workpiece 412 to prevent movement or rotation thereof. The fixture 400 may be equipped with a buffer mechanism 402 to provide buffer when obtaining the workpiece 412, avoiding damage to the workpiece 412 due to excessive pressure. Additionally, the fixture 400 is configured for quick disassembly, allowing quick disassembly through a quick female connector 404 and quick male connector 406, facilitating replacement of different types of fixtures 400, or maintenance or replacement of the fixtures 400. In some embodiments, the fixture 400 may be of other types, such as an arm that physically grips from the side of the workpiece 412, or a magnetic fixture. Based on the present disclosure, a suitable fixture 400 can be selected according to the actual application.

FIG. 5 is a schematic diagram of a top vision platform 500 according to an embodiment of the present disclosure. In this embodiment, the top vision platform 500 has two material slots 502 for accommodating workpieces. The top vision platform 500 moves in the X-axis direction through a top vision platform X-axis 504 to transport the workpieces to the appropriate position according to the inspection process. The top vision platform 500 can correspond to the top vision platform 106 in FIGS. 1A and 1B. For example, as previously described with FIGS. 1A and 1B, during pick-up, the top vision platform 500 can move close to the loading machine 102, facilitating the picking module 104 to place the workpieces obtained from the loading machine 102 on the top vision platform 500. Then, one or both of the top vision platform 500 and the top vision module 114 can move, allowing the top vision module 114 to conduct inspection from above the workpieces. After the top vision module 114 completes the inspection, the top vision platform 500 moves the carried workpieces to the receiving module 108 to facilitate the receiving module 108 to obtain the workpieces for subsequent inspection. Additionally, as shown in FIG. 5, there is a spacing between the two material slots 502, where the picking pitch-adjusting module (e.g. the picking pitch-adjusting module 304 in FIG. 3) of the picking module (e.g., the picking module 300 in FIG. 3) can adjust the distance between the two workpieces to match the spacing between the material slots 502 of the top vision platform 500.

In some embodiments, the top vision platform 500 may have more or fewer material slots 502, and the shape of the material slots 502 may be adjusted based on actual needs.

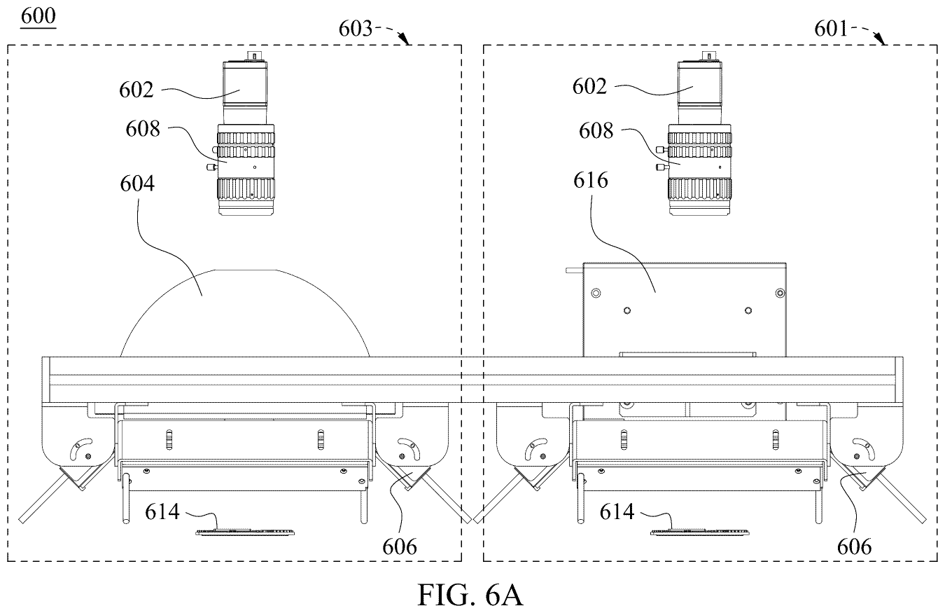

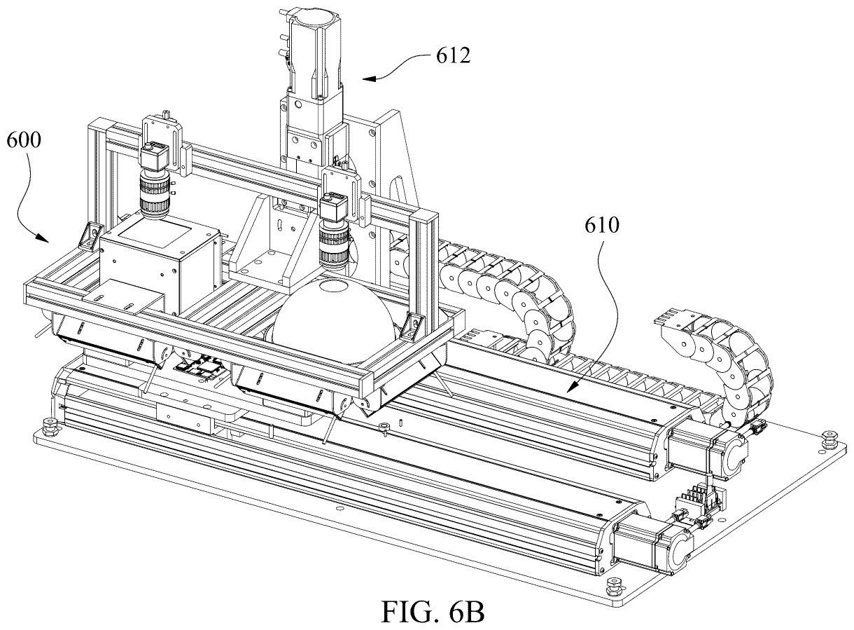

FIGS. 6A and 6B illustrate a top vision module 600 according to an embodiment of the present disclosure from different angles. Referring to FIGS. 6A and 6B, the top vision module 600 includes a top-view camera 602, capable of obtaining a top image of a workpiece 614 from above. The top vision module 600 includes a top vision lens 608 to see the details of the workpiece 614 more clearly, and the top vision module 600 is coupled to a top vision Z-axis 612 to adjust the distance between the top vision lens 608 or the top-view camera 602 and the workpiece 614, allowing the top vision lens 608 to focus on the workpiece 614. The top vision module 600 further includes a top lighting set, which can be configured with different types of light sources based on needs. For example, in the embodiment of FIGS. 6A and 6B, the top lighting set of the top vision module 600 includes three different light sources: a top dome light 604, a top light bar 606 and a top coaxial light 616. The top vision module 600 in this embodiment includes a first part 601 and a second part 603. The first part 601 of the top vision module 600 includes the top coaxial light 616 and the top light bar 606, the second part 603 of the top vision module 600 includes the top dome light 604 and the top light bar 606, and the first part 601 and the second part 603 each have a top-view camera 602 and a top vision lens 608. It should be noted that the left and right labeling of the first part 601 and the second part 603 in FIG. 6A is only an example, the present disclosure does not limit the position and the combination of components of the first part 601 and the second part 603. The top dome light 604 and the top coaxial light 616 are different types of light sources, but both approximately illuminate from directly above the workpiece 614. The top light bar 606 is disposed on the outer periphery of the top dome light 604, illuminating from above the workpiece 614 at an inclined angle, and the angle between the illumination direction of the top light bar 606 and the illumination direction of the top dome light 604 is approximately 45 degrees. Similarly, another set of top light bars 606 is disposed on the outer periphery of the top coaxial light 616, and the angle between the illumination direction of the top light bar 606 and the illumination direction of the top coaxial light 616 is approximately 45 degrees. The light source arrangement in this embodiment can provide different types of illumination for different inspection items. In other embodiments, other types or numbers of light sources may be used as needed.

As shown in FIG. 6B, the top vision module 600 is coupled to a top vision X-axis 610 and the top vision Z-axis 612 to move in the X-axis direction and Z-axis direction, which are perpendicular to each other.

The top vision module 600 may conduct one or more different inspection items on the workpiece 614. For example, in the embodiment of FIGS. 6A and 6B, the first part 601 and the second part 603 of the top vision module 600 conduct different inspection items on two workpieces 614 respectively. In some embodiments, the inspection items include at least one or more of the following: color difference, scratches, contaminants, exposed substrate, dents, imprints, glue overflow, part damage or missing, defective punching, incorrect punching, part deviation or misalignment, pattern or text quality issues, barcode reading failure, appearance length or width out of specification, or other items that can be visually inspected, etc. The steps for the top vision module 600 to conduct inspection items are as follows:
(1) Move the top vision module 600 on the top vision X-axis 610, advancing towards the top vision platform, where the top vision platform carries two workpieces to be inspected. At this time, the position of the top vision module 600 has not yet overlapped with the two workpieces;
(2) After moving, the position of the first part 601 of the top vision module 600 overlaps with the first workpiece, allowing the first part 601 of the top vision module 600 to be above the first workpiece; the first part 601 of the top vision module 600 conducts inspection items on the first workpiece. At this time, the position of the second part 603 of the top vision module 600 has not yet overlapped with any workpiece;
(3) Continue moving the top vision module 600 in the same direction as step (1), allowing the position of the first part 601 of the top vision module 600 to overlap with the second workpiece, and the position of the second part 603 of the top vision module 600 to overlap with the first workpiece; the first part 601 of the top vision module 600 conducts inspection items on the second workpiece, the second part 603 of the top vision module 600 conducts inspection items on the first workpiece, where the inspection items of the first part 601 and the second part 603 may be completely the same, completely different, or partially the same;
(4) Continue moving the top vision module 600 in the same direction as step (1), allowing the position of the second part 603 of the top vision module 600 to overlap with the second workpiece, the second part 603 of the top vision module 600 conducts inspection items on the second workpiece. At this time, the position of the first part 601 of the top vision module 600 does not overlap with any workpiece;
(5) After the above steps (1)-(4), both the first part 601 and the second part 603 of the top vision module 600 have completed inspection items on the two workpieces, so move the top vision module 600 in the opposite direction back to the original position of step (1).

FIG. 7 is a schematic diagram of a receiving module 700 according to an embodiment of the present disclosure. The receiving module 700 includes a receiving fixture 710, which can be, for example, the fixture 400 described in FIG. 4, used to obtain and hold the workpiece from the top vision platform for subsequent bottom and side visual inspections. In the embodiment of FIG. 7, the receiving fixture 710 is coupled to a receiving rotation shaft 708, allowing the receiving fixture 710 to rotate. In this embodiment, the receiving module 700 further includes a receiving pitch-adjusting module 704, with two receiving fixtures 710 coupled to it. The receiving pitch-adjusting module 704 is further coupled to a receiving X-axis 702. The configuration of the receiving pitch-adjusting module 704 and the receiving X-axis 702 provides various ways to move the workpieces in the X-axis direction. For example, the receiving pitch-adjusting module 704 may change the center distance D between the two receiving fixtures 710, move the two receiving fixtures 720 in parallel through the receiving X-axis 702 while maintaining the center distance D fixed, or simultaneously change the center distance D and move the two receiving fixtures 710 through the receiving X-axis 702. A receiving Z-axis 706 is coupled between the receiving fixture 710 and the receiving pitch-adjusting module 704, enabling the receiving fixture 710 to move in the Z-axis direction for conveniently obtaining, positioning, or placing the workpieces. The receiving pitch-adjusting module 704 can adjust the center distance D between the two workpieces to match the spacing of the side vision module and/or bottom vision module in subsequent process step. Additionally, in some embodiments, due to the miniaturized design of the receiving Z-axis 706, the minimum center distance D between the two receiving fixtures 710 on the receiving pitch-adjusting module 704 can be shortened to 4.5 cm; when the distance between the two material slots of the top vision platform is greater than the aforementioned center distance D (4.5 cm), the receiving module 700 can pick up two workpieces from the material slots at once.

As previously described in FIG. 3, in some embodiments, changes can be made to the picking module 300, and these changes can also be applied to the receiving module 700 in FIG. 7, which will not be described herein.

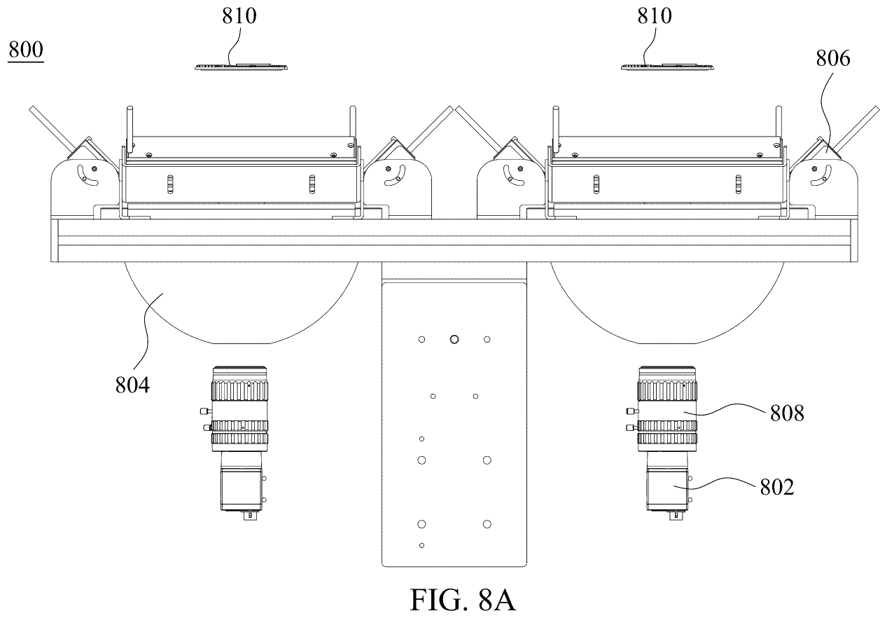

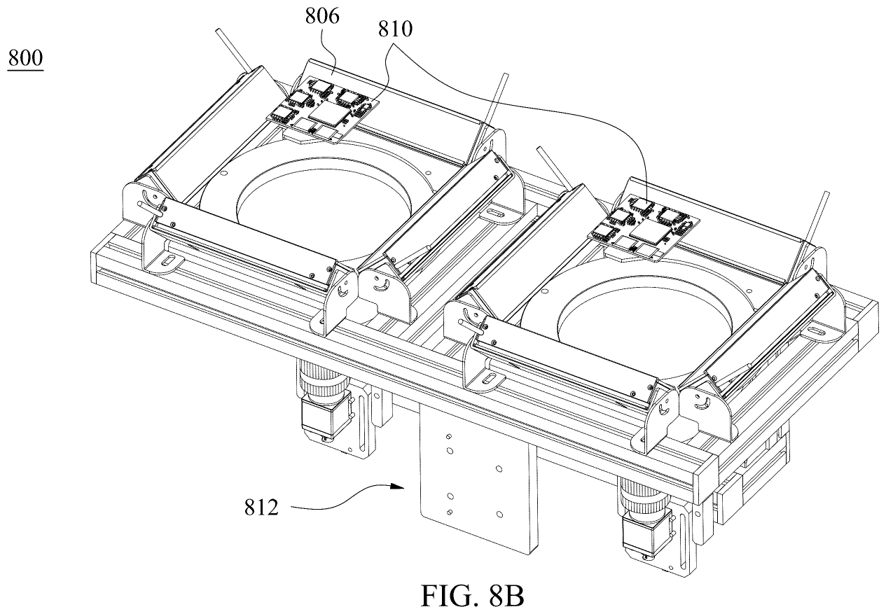

FIGS. 8A and 8B illustrate a bottom vision module 800 according to an embodiment of the present disclosure from different angles. Referring to FIGS. 8A and 8B, after the receiving module (not shown in FIGS. 8A and 8B) obtains the workpiece 810 from the top vision platform (not shown in FIGS. 8A and 8B), it holds the workpiece 810 above the bottom vision module 800 for inspection. The bottom vision module 800 can conduct the same or different visual inspections as the top vision module (e.g., the top vision module 600 in FIG. 6A). The bottom vision module 800 includes a bottom-view camera 802, capable of obtaining a bottom image of the workpiece 810 from below. The bottom vision module 800 can include a bottom vision lens 808 to see the details of the workpiece 810 more clearly. The bottom vision module 800 can be coupled to a bottom vision Z-axis 812 to adjust the distance between the bottom vision lens 808 or the bottom-view camera 802 and the workpiece 810, allowing the bottom vision lens 808 to focus on the workpiece 810. The bottom vision module 800 further includes a bottom lighting set, which can be configured with different types of light sources based on needs. For example, in the embodiment of FIGS. 8A and 8B, the bottom lighting set of the bottom vision module 800 includes two different light sources: a bottom dome light 804 and a bottom light bar 806. The bottom dome light 804 approximately illuminates from directly below the workpiece 810. The bottom light bar 806 is disposed on the outer periphery of the bottom dome light 804, illuminating from below the workpieces 810 at an inclined angle, and the angle between the illumination direction of the bottom light bar 806 and the illumination direction of the bottom dome light 804 is approximately 45 degrees. The light source arrangement in this embodiment may conduct different types of illumination for different inspection items. In some embodiments, other different types or numbers of light sources can be used based on needs. Furthermore, although the bottom vision module 800 is illustrated as including two bottom-view cameras 802, two bottom vision lenses 808, and two bottom lighting sets, alternative embodiments may employ a greater or lesser number of such components, and the present disclosure is not limited thereto.

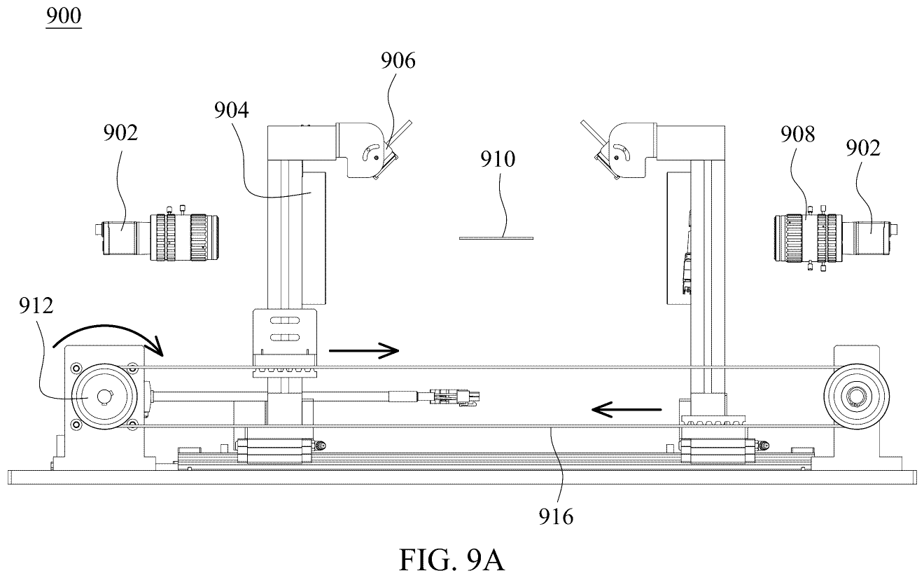

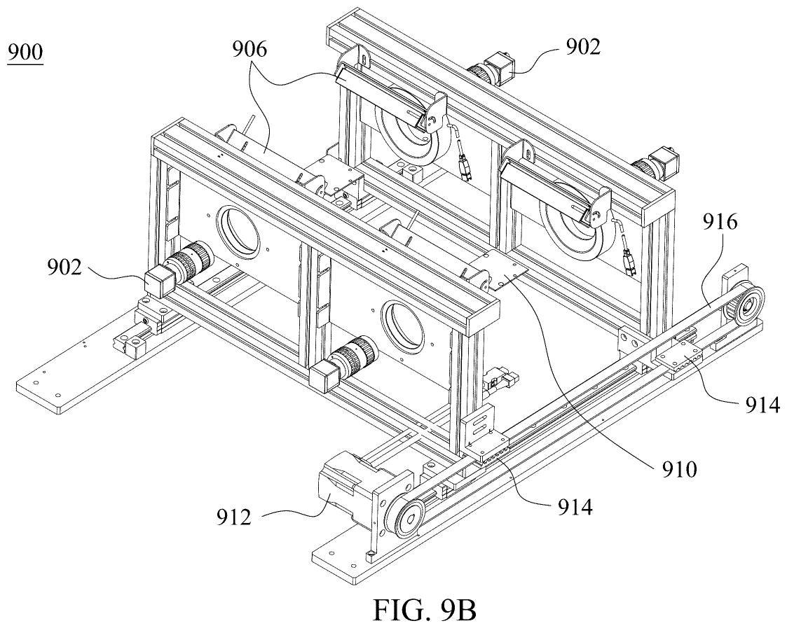

FIGS. 9A and 9B illustrate a side vision module 900 according to an embodiment of the present disclosure from different angles. Referring to FIGS. 9A and 9B, the side vision module 900 includes a pair of side-view cameras 902. After the receiving module (not shown in FIGS. 9A and 9B) obtains the workpiece 910 from the top vision platform (not shown in FIGS. 9A and 9B), it holds the workpiece 910 between the side-view cameras 902 of the side vision module 900 for inspection. The side vision module 900 can conduct the same or different visual inspections as the top vision module (e.g., the top vision module 600 in FIG. 6A). The side-view cameras 902 of the side vision module 900 can obtain side images of the workpieces 910 from the sides. The side vision module 900 includes side vision lenses 908 to see the details of the workpiece 910 more clearly. The side vision module 900 may be coupled to a side vision Y-axis to adjust the distance between the side vision lenses 908 or the side-view cameras 902 and the workpiece 910, allowing the side vision lenses 908 to focus on the workpiece 910. The side vision Y-axis may include a motor 912 and a belt 916 coupled to the motor 912, where the side vision module 900 clamps the belt 916 at a clamping point 914 so as to be moved by the motor 912 in the Y-axis direction.

The side vision module 900 further includes a side vision lighting set, which can be configured with different types of light sources based on needs. For example, in the embodiment of FIGS. 9A and 9B, the side vision lighting set of the side vision module 900 includes two different light sources: a side ring shadowless light 904 and a side vision light bar 906. The side light bar 906 is disposed on the outer periphery (e.g., above) of the side ring shadowless light 904, illuminating from the side of the workpiece 910 at an inclined angle, and the angle between the illumination direction of the side light bar 906 and the illumination direction of the side ring shadowless light 904 is approximately 45 degrees. The light source configuration in this embodiment can provide different types of illumination for different inspection items. In some embodiments, other different types or numbers of light sources can be used based on needs. Furthermore, although the side vision module 900 is illustrated as including two side-view cameras 902, two side vision lenses 908, and two side lighting sets, alternative embodiments may employ a greater or lesser number of such components, and the present disclosure is not limited thereto.

The side vision module 900 has a pair of side-view cameras 902, so that when the receiving module places the workpiece 910 between the side-view cameras 902, the side vision module 900 can simultaneously obtain a first pair of side images from two sides of the workpiece 910 for inspection. Then, the receiving module uses the receiving rotation shaft to rotate the workpiece 910, for example, rotating 90 degrees, allowing the side-view cameras 902 to obtain a second pair of side images from the other two sides of the workpiece 910 for inspection. This allows inspection of the four faces of the workpieces 910 by simple rotation without needing to translate the workpiece 910. Since this design can complete the imaging of the four sides of the workpiece 910 with the same side vision module 900, it reduces the movement and transfer actions of the workpiece 910 and the required structure, achieving the effect of saving time, reducing costs, and saving space. In some embodiments, the present disclosure can be applied to workpieces 910 of shapes other than squares, which can be rotated by angles other than 90 degrees based on needs.

Additionally, side visual inspection and bottom visual inspection can be conducted simultaneously. Referring to FIGS. 8A-9B, while the side vision module 900 conducts inspection from the side of the workpieces 810, 910, the bottom vision module 800 can conduct inspection from below the workpieces 810, 910. For example, the bottom image obtained by the bottom vision module 800 can be captured simultaneously with the first pair of side images obtained by the side vision module 900, and/or the bottom image obtained by the bottom vision module 800 can be captured simultaneously with the second pair of side images obtained by the side vision module 900. The above design of the side vision module 900 and the bottom vision module 800 in the present disclosure also achieves the effect of saving time, reducing costs, and saving space.

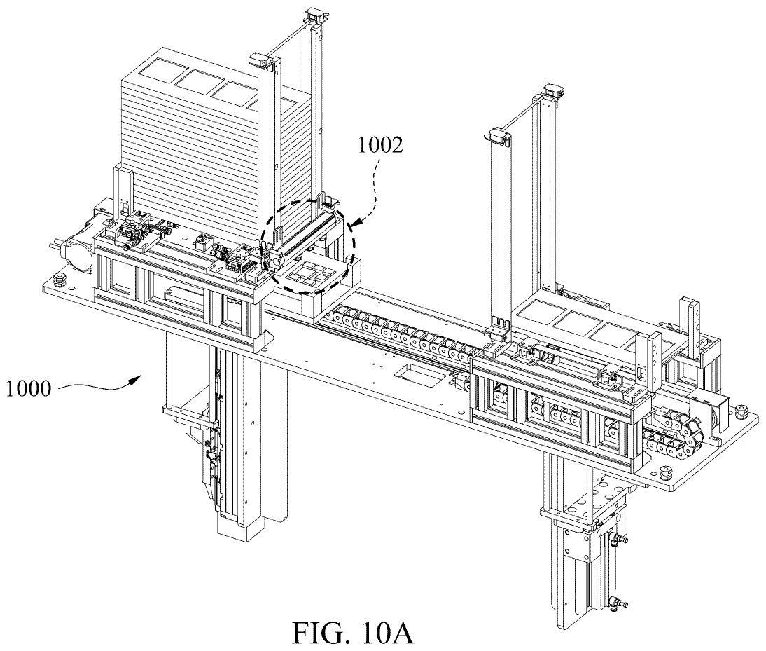

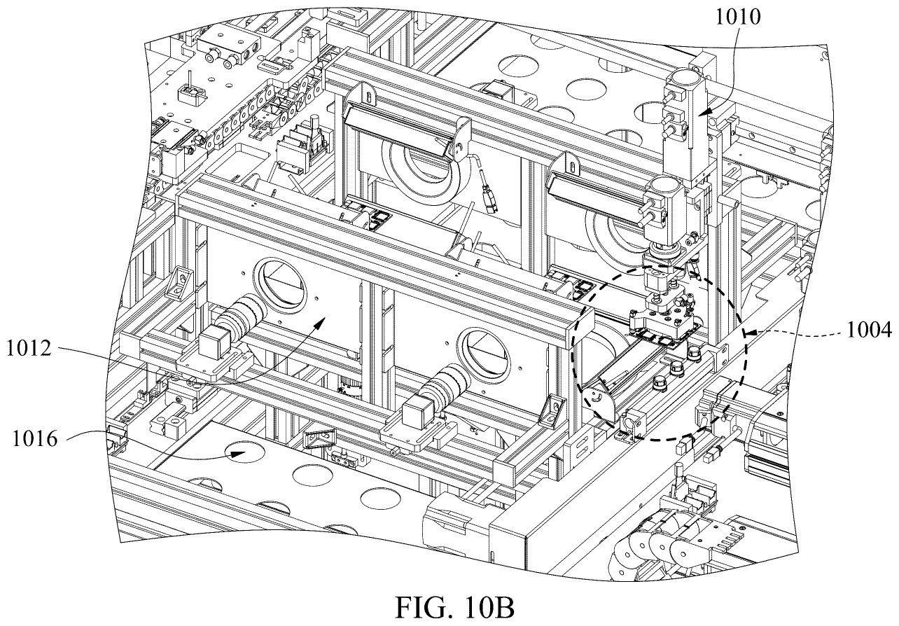

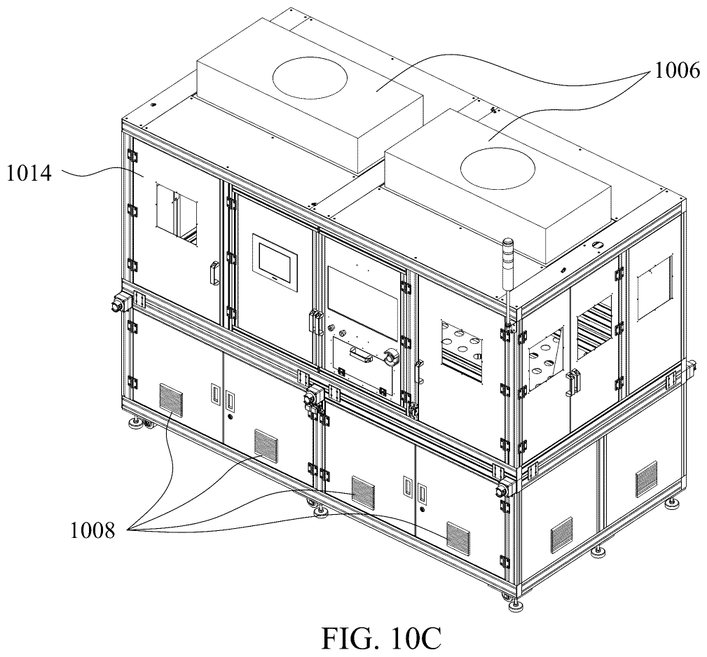

FIGS. 10A-10C disclose some embodiments of removing particles in the present disclosure. Particles may adhere to the workpieces to be inspected, affecting inspection quality. To remove particles, the technical means shown in FIGS. 10A-10C can be used. In the embodiment shown in FIG. 10A, the loading machine 1000 includes an ionizer bar 1002, with the ionizer bar 1002 removing particles from above the workpieces to prevent particles from affecting subsequent top visual inspection. In the embodiment shown in FIG. 10B, the bottom vision module 1012 includes an ionizer bar 1004, which removes particles from below the workpieces held by the receiving module 1010 before the bottom vision module 1012 conducts bottom visual inspection to prevent particles from affecting bottom visual inspection. The removed particles fall through holes 1016 to the bottom of the inspection system. FIG. 10C shows the inspection system covered by a housing 1014. The housing 1014 prevents external particles from entering the inspection system and affecting the inspection; additionally, the housing 1014 may be equipped with an ULPA (Ultra-Low Particulate Air filter) 1006 and a fan 1008. The inspection system blows filtered air down through the ULPA 1006; the particles are blown down and fall through the holes 1016 in FIG. 10B to the bottom of the inspection system, then expelled outside the inspection system through the fan 1008.

The present disclosure reveals various aspects of the inspection system. Among them, the configuration of the picking module, top vision module, receiving module, bottom vision module and side vision module of the present disclosure makes the inspection process faster, the system size smaller, and saves equipment manufacturing costs.

In some variation embodiments of the present disclosure, the order of top, bottom, and side visual inspections can be adjusted.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. An inspection module for inspecting a workpiece, comprising:
a receiving module comprising:
a receiving fixture, configured to hold the workpiece; and
a receiving rotation shaft coupled to the receiving fixture and configured to rotate the receiving fixture; and
a side vision module, comprising a pair of side-view cameras;
wherein the receiving module is configured to:
place the workpiece held by the receiving fixture between the pair of side-view cameras, allowing the pair of side-view cameras to capture a first pair of side images of the workpiece; and
rotate the workpiece held by the receiving fixture by an angle through the receiving rotation shaft, allowing the pair of side-view cameras to capture a second pair of side images of the workpiece;
wherein the first pair of side images and the second pair of side images correspond to different side-view positions of the workpiece.

2. The inspection module according to claim 1, further comprising a bottom vision module, the bottom vision module comprising a bottom-view camera configured to capture a bottom image of the workpiece held by the receiving fixture from below the workpiece.

3. The inspection module according to claim 2, wherein the bottom image is captured simultaneously with the first pair of side images, and/or the bottom image is captured simultaneously with the second pair of side images.

4. The inspection module according to claim 2, wherein the bottom vision module further comprises a bottom vision Z-axis, the bottom-view camera being coupled to the bottom vision Z-axis, and the bottom vision Z-axis being configured to adjust a distance between the bottom-view camera and the workpiece.

5. The inspection module according to claim 1, wherein the side vision module comprises a side vision Y-axis, the side vision Y-axis being configured to adjust a distance between the pair of side-view cameras and the workpiece.

6. The inspection module according to claim 1, wherein the receiving module further comprises a receiving X-axis and a receiving Z-axis, the receiving fixture being coupled to the receiving X-axis and the receiving Z-axis, wherein the receiving X-axis enables the receiving fixture to translate in an X-axis direction, the receiving Z-axis enables the receiving fixture to translate in a Z-axis direction, and the X-axis direction and the Z-axis direction are perpendicular to each other.

7. The inspection module according to claim 6, wherein the receiving module comprises two receiving fixtures, and the receiving module further comprises a receiving pitch-adjusting module, the receiving pitch-adjusting module being coupled to the receiving X-axis and the two receiving fixtures, the receiving pitch-adjusting module being configured to adjust a center distance between the two receiving fixtures in the X-axis direction, or to move the two receiving fixtures in parallel via the receiving X-axis while maintaining the center distance fixed.

8. The inspection module according to claim 7, wherein the center distance is at least 4.5 cm.

9. The inspection module according to claim 1, wherein the angle is 90 degrees.

10. An inspection system for inspecting a workpiece, comprising:
a picking module, comprising a picking fixture, the picking fixture being configured to hold the workpiece;
a top vision platform, configured to support the workpiece from the picking fixture, wherein the picking fixture is configured to place the workpiece on the top vision platform while the picking fixture is located within a safety zone;
a top vision module, comprising a top-view camera, the top-view camera being configured to capture a top image of the workpiece carried on the top vision platform from above the workpiece;
a receiving module, comprising a receiving fixture and a receiving rotation shaft, the receiving fixture being configured to acquire and hold the workpiece from the top vision platform, the receiving rotation shaft being coupled to the receiving fixture and configured to rotate the receiving fixture;
a bottom vision module, comprising a bottom-view camera, the bottom-view camera being configured to capture a bottom image of the workpiece held by the receiving fixture from below the workpiece; and
a side vision module, comprising a side-view camera, the side-view camera being configured to capture a side image of the workpiece held by the receiving fixture from a side of the workpiece;
wherein:
during a period in which the picking fixture places the workpiece on the top vision platform, the picking fixture enters the safety zone and the top vision module is retracted from the safety zone; and
during a period in which the top vision module captures the top image of the workpiece, the top vision module enters the safety zone and the picking fixture is retracted from the safety zone.

11. The inspection system according to claim 10, wherein during the period in which the picking fixture places the workpiece on the top vision platform, the receiving module moves the receiving fixture above the bottom vision module.

12. The inspection system according to claim 10, wherein the receiving module is configured to:
place the workpiece held by the receiving fixture in front of the side-view camera, allowing the side-view camera to capture a first side image of the workpiece; and
rotate the workpiece held by the receiving fixture by an angle through the receiving rotation shaft, allowing the side-view camera to capture a second side image of the workpiece;
wherein the first side image and the second side image correspond to different side-view positions of the workpiece.

13. The inspection system according to claim 12, wherein the bottom image is captured simultaneously with the first side image, and/or the bottom image is captured simultaneously with the second side image.

14. The inspection system according to claim 10, wherein one or more of the top vision module, the bottom vision module, and the side vision module further comprise: a lighting set and a light bar, the lighting set and the light bar being configured to illuminate the workpiece, wherein the light bar is disposed on an outer periphery of the lighting set, and an included angle between an illumination direction of the light bar and an illumination direction of the lighting set is approximately 45 degrees.

15. The inspection system according to claim 10, wherein:
the picking module further comprises a picking X-axis, a picking pitch-adjusting module, and two picking fixtures, the picking X-axis enables the picking fixtures to translate in an X-axis direction, the picking pitch-adjusting module is coupled to the picking X-axis and the two picking fixtures, and the picking pitch-adjusting module is configured to adjust a distance between the two picking fixtures in the X-axis direction, or to move the two picking fixtures in parallel via the picking X-axis while maintaining the distance fixed; and
during the period in which the top vision module captures the top image of the workpiece, the picking pitch-adjusting module shortens the distance between the two picking fixtures to allow the two picking fixtures to retract from the safety zone.

16. The inspection system according to claim 10, wherein the picking fixture and/or the receiving fixture comprise a contact suction cup and a non-contact suction cup, the contact suction cup being distributed around a periphery of the non-contact suction cup, wherein the non-contact suction cup is configured to non-contactly adsorb a central area of the workpiece, the contact suction cup is configured to contactly adsorb a peripheral area of the workpiece.

17. The inspection system according to claim 10, wherein when the top vision module and the workpiece on the top vision platform overlap, the top vision module captures the top image of the workpiece.

18. The inspection system according to claim 10, wherein the bottom vision module further comprises an ionizer bar, the ionizer bar being configured to remove particles from below the workpiece held by the receiving fixture before the bottom-view camera captures the bottom image of the workpiece.

19. The inspection system according to claim 10, further comprising a loading and unloading machine, the loading and unloading machine comprising: a picking position, a tray pickup stacking position, a transfer mechanism and a stacking Z-axis, wherein:
the transfer mechanism is configured to carry a tray loaded with the workpiece and move the tray to the picking position for the picking module to obtain the workpiece;
after the picking module obtains the workpiece, move the empty tray to the tray pickup stacking position;
the stacking Z-axis is configured to push the tray on the transfer mechanism upward at the tray pickup stacking position to disengage the tray from the transfer mechanism;
when the tray disengages from the transfer mechanism, the stacking Z-axis moves downward to make space for the transfer mechanism to leave the tray pickup stacking position.

20. An inspection module for inspecting a workpiece, comprising:
a picking module, comprising a picking fixture, the picking fixture being configured to hold the workpiece;
a top vision platform, configured to support the workpiece from the picking fixture;
a top vision module, comprising a top-view camera, the top-view camera being configured to capture a top image of the workpiece carried on the top vision platform from above the workpiece;
a receiving module, comprising: a receiving fixture and a receiving rotation shaft, the receiving fixture being configured to acquire and hold the workpiece from the top vision platform, the receiving rotation shaft being coupled to the receiving fixture and configured to rotate the receiving fixture;
a bottom vision module, comprising a bottom-view camera, the bottom-view camera being configured to capture a bottom image of the workpiece held by the receiving fixture from below the workpiece; and
a side vision module, comprising a pair of side-view cameras;
wherein the receiving module is configured to:
place the workpiece held by the receiving fixture between the pair of side-view cameras, allowing the pair of side-view cameras to capture a first pair of side images of the workpiece;
rotate the workpiece held by the receiving fixture by an angle through the receiving rotation shaft, allowing the pair of side-view cameras to capture a second pair of side images of the workpiece;
wherein the bottom image is captured simultaneously with the first pair of side images, and/or the bottom image is captured simultaneously with the second pair of side images.
